(19) United States
(12) Patent Application Publication
(10) Pub. No.: US 2025/0245099 A1
(43) Pub. Date: Jul. 31, 2025

(54) APPARATUSES AND METHODS TO PERFORM SELF-SCRUB OPERATIONS AT A MEMORY

(71) Applicant: Micron Technology, Inc., Boise, ID (US)

(72) Inventors: Graziano MIRICHIGNI, Vimercate (IT); Marco SFORZIN, Cernusco Sul Naviglio (IT); John NAMKUNG, Cupertino, CA (US)

(73) Assignee: Micron Technology, Inc., Boise, ID (US)

(21) Appl. No.: 19/037,122

(22) Filed: Jan. 25, 2025

Related U.S. Application Data
(60) Provisional application No. 63/625,143, filed on Jan. 25, 2024.

(51) Int. Cl. G06F 11/10

(52) U.S. Cl. CPC G06F 11/106; G06F 11/1016; G06F 11/1068

(57) ABSTRACT

An exemplary system includes a memory comprising an error correction code (ECC) circuit and a scrub circuit, The ECC, during a read operation corresponding to a first read command, detects and corrects an error in read data read from a target row of a memory cell array using an ECC and to provide corrected read data and a ECC error alert (EEA) signal having a value based on a number of errors detected in the read data. The scrub circuit, during the read operation and in response to self-scrub mode being enabled, causes the corrected read data to be written back to the target row of the memory cell array in response to the EEA having a scrub required value.

### CROSS-REFERENCE TO RELATED APPLICATIONS

This application claims the filing benefit of U.S. Provisional Application No. 63/625,143, filed Jan. 25, 2024. This application is incorporated by reference herein in its entirety and for all purposes.

### BACKGROUND OF THE INVENTION

High data reliability and high speed of memory access are features that are demanded from semiconductor memory. Some conditions in a memory may cause one or more bits of a piece of data stored in memory may flip to an incorrect value, such as improper refresh, weak cells, voltage loss, etc. To protect data integrity, the memories may employ various error correction algorithms capable of detecting and/or correcting some data errors to assist with data integrity. However, these error correction algorithms are generally employed to correct requested data prior to transmission, rather than correcting the corrupted data stored at the memory.

### BRIEF DESCRIPTION OF THE DRAWINGS

FIG. 1 is a schematic block diagram of a semiconductor device, in accordance with an embodiment of the present disclosure.

FIG. 2 is a schematic block diagram of a memory system having a portion of a semiconductor device coupled to a memory controller, in accordance with an embodiment of the present disclosure.

FIG. 3 is a timing diagram of a read operation with no self-scrub operation at a semiconductor device, in accordance with an embodiment of the present disclosure.

FIG. 4 is a timing diagram of a read operation with a self-scrub operation at a semiconductor device, in accordance with an embodiment of the present disclosure.

FIG. 5 includes a table that illustrates when a self-scrub operation is performed, in accordance with embodiments described herein.

### DETAILED DESCRIPTION

Certain details are set forth below to provide a sufficient understanding of embodiments of the present disclosure. However, it will be clear to one skilled in the art that embodiments of the present disclosure may be practiced without these particular details. Moreover, the particular embodiments of the present disclosure described herein are provided by way of example and should not be used to limit the scope of the disclosure to these particular embodiments. In other instances, well-known circuits, control signals, timing protocols, and software operations have not been shown in detail in order to avoid unnecessarily obscuring the disclosure.

This disclosure describes examples of a semiconductor device capable of performing a self-controlled scrub of inconsistent (e.g., corrupted, incorrect, erroneous, etc.) data stored at a memory. The self-controlled scrub may include a memory embedded management technique to control a raw bit error rate (RBER) increase by refreshing a memory row through the scrub operation to fix existing errors during an error correction code (ECC) correctable read operation. Typically, scrub operations are initiated and controlled by a memory controller and include effectively performing an entire write operation to correct the inconsistent data. Correcting the inconsistent data during the read operation may slightly increase a time before a next memory access command may be issued by the memory controller, but overall saves time and power because there is no data exchange between the memory controller and the memory device to perform a write back operation of the corrected data.

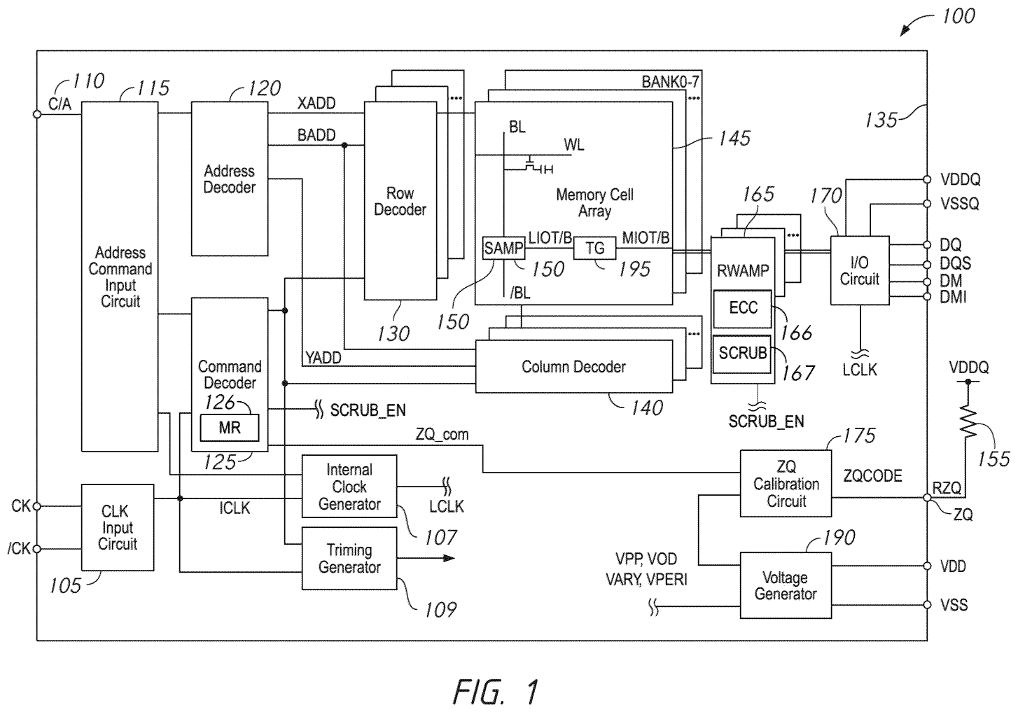

FIG. 1 is a schematic block diagram of a semiconductor device 100, in accordance with an embodiment of the present disclosure. For example, the semiconductor device 100 may include a chip 135 and a ZQ resistor (RZQ) 155. The chip 135 may include a clock input circuit 105, an internal clock generator 107, a timing generator 109, an address command input circuit 115, an address decoder 120, a command decoder 125, a control circuit 126, a plurality of row decoders 130, a memory cell array 145 including sense amplifiers 150 and transfer gates 195, a plurality of column decoders 140, a plurality of read/write amplifiers 165, an input/output (I/O) circuit 170, a 172, the ZQ resistor (RZQ) 155, a ZQ calibration circuit 175, and a voltage generator 190. The semiconductor device 100 may include a plurality of external terminals including address and command terminals coupled to command/address bus 110, clock terminals CK and/CK, data terminals DQ, DQS, and DM, power supply terminals VDD, VSS, VDDQ, and VSSQ, and a calibration terminal ZQ. The chip 135 may be mounted on a substrate 160, for example, a memory module substrate, a mother board or the like. The semiconductor device 100 may include volatile memory cells and may be implemented in a dynamic, random-access memory (DRAM) device, such as a double data rate (DDR) 4, DDR5, DDR6, low power DDR5 (LPDDR5), graphics DDR (GDDR) 4/5/6, etc., DRAM devices. In some examples, the semiconductor device 100 may include some non-volatile memory cells, such as those implemented in NAND flash memory.

The memory cell array 145 includes a plurality of banks BANK0-N, each bank BANK0-N including a plurality of word lines WL, a plurality of bit lines BL, and a plurality of memory cells MC arranged at intersections of the plurality of word lines WL and the plurality of bit lines BL. The number of banks BANK0-N may include 2, 4, 8, 16, or any other number of banks. The selection of the word line WL for each bank is performed by a corresponding row decoder 130 and the selection of the bit line BL is performed by a corresponding column decoder 140. The plurality of sense amplifiers 150 are located for their corresponding bit lines BL and coupled to at least one respective local I/O line further coupled to a respective one of at least two main I/O line pairs, via transfer gates TG 195, which function as switches.

The address/command input circuit 115 may receive an address signal and a bank address signal from outside at the command/address terminals via the command/address bus 110 and transmit the address signal and the bank address signal to the address decoder 120. The address decoder 120 may decode the address signal received from the address/command input circuit 115 and provide a row address signal XADD to the row decoder 130, and a column address signal YADD to the column decoder 140. The address decoder 120 may also receive the bank address signal and provide the bank address signal BADD to the row decoder 130 and the column decoder 140.

The address/command input circuit 115 may receive a command signal from outside, such as, for example, a memory controller 105 at the command/address terminals via the command/address bus 110 and provide the command signal to the command decoder 125. The command decoder 125 may decode the command signal and provide generate various internal command signals. For example, the internal command signals may include a row command signal to select a word line, a column command signal, such as a read command or a write command, to select a bit line, a mod register setting command MRS that may cause mode register settings to be stored at the control circuit 126, and a ZQ calibration command ZQ_com that may activate the ZQ calibration circuit 175.

Accordingly, when a read command is issued and a row address and a column address are timely supplied with the read command, read data is read from a memory cell in the memory cell array 145 designated by the row address and the column address. The read/write amplifiers 165 may receive the read data DQ and provide the read data DQ to the IO circuit 170. The IO circuit 170 may provide the read data DQ to outside via the data terminals DQ, together with a data strobe signal at DQS and/or a data mask signal at DM. Similarly, when the write command is issued and a row address and a column address are timely supplied with the write command, and then the input/output circuit 170 may receive write data at the data terminals DQ, together with a data strobe signal at DQS and/or a data mask signal at DM and provide the write data via the read/write amplifiers 165 to the memory cell array 145. Thus, the write data may be written in the memory cell designated by the row address and the column address.

During both read and write operations, the column decoders 140 may drive column select CS signals and the plurality of read/write amplifiers 165 may drive a respective pair of the main IO lines to complementary logical voltage polarities based on the row and column addresses. During the write operation, an ECC circuit 166 of the plurality of read/write amplifiers 165 may generate a corresponding ECC based on the data and the plurality of read/write amplifiers 165 may cause the ECC to be stored at the memory cell array 145 along with the data. During a read operation, the plurality of read/write amplifiers 165 may cause the data along with the corresponding ECC to be read from the memory cell array 145, and the ECC circuit 166 may use the ECC to determine whether the data read from the memory matches expected data. In some examples, the ECC circuit 166 may be capable of correcting the errors in the data using the ECC prior to provision to the I/O circuit 170. However, the data stored at the memory cell array 145 may remain corrupted until a scrub operation is performed. The semiconductor device 100 may notify the memory controller of the corrupted data. For example, the ECC circuit 166, via the I/O circuit 170, may send an ECC error alert signal EEA, along with the corrected data, to the memory controller via a direct media interface (DMI) terminal to notify the memory controller. Depending on a mode of operation, the memory controller or the semiconductor device 100 may initiate a scrub operation. For example, in one mode, a scrub operation may be initiated by a memory controller in response to the EEA signal indicating that the stored data is corrupted. When initiated by the memory controller, the scrub operation is effectively a full write back operation.

However, when the semiconductor device 100 is configured for self-controlled scrub operations (e.g., self-controlled scrub mode enabled), a scrub circuit 167 of the plurality of read/write amplifiers 165 may be configured to cause corrected data to be written back to the memory cell array 145 as part of the read operation. In some examples, the scrub operation may be limited to certain error correction modes. For example, if the ECC circuit 166 is capable of correcting up to two detected bit errors, the scrub circuit 167 may only perform a scrub operation when two bit errors are detected (e.g., and not perform a scrub operation when only one bit error is detected). In other examples, the scrub circuit 167 may be configured to perform a scrub operation when any number of correctable bit errors are detected.

The self-controlled scrub mode may be enabled by a mode register setting stored at the mode register 126. The scrub enabled setting SCRUB_EN may be read from the mode register 126 by the plurality of read/write amplifiers 165. When enabled, when the ECC circuit 166 performs a prescribed data correction, the scrub circuit 167 may be configured to receive the corrected data and cause it to be written back to the memory cell array 145. If the 267 initiates a scrub operation, the semiconductor device 100 may still provide the EEA signal with the corrected data to the memory controller, and in response to the EEA signal having a value indicating a scrub will be performed, the memory controller may delay initiation of a next access operation (or may delay a time to sense data from the data terminals DQ if the subsequent access operation has been initiated) to allow the scrub operation to complete. That is, correcting the inconsistent data during the read operation may introduce a small delay or a small increase in latency as compared with a normal read operation, but may save time and power overall as compared with a scrub operation controlled by the memory controller (e.g., an operation that includes performing a full write back operation with data transfer over a data bus to the semiconductor device 100).

Turning to the explanation of the external terminals included in the semiconductor device 100, the clock terminals CK and/CK may receive an external clock signal and a complementary external clock signal, respectively. The external clock signals (including complementary external clock signal) may be supplied to a clock input circuit 105. The clock input circuit 105 may receive the external clock signals and generate an internal clock signal ICLK. The clock input circuit 105 may provide the internal clock signal ICLK to an internal clock generator 107. The internal clock generator 107 may generate a phase controlled internal clock signal LCLK based on the received internal clock signal ICLK and a clock enable signal CKE from the address/command input circuit 115. Although not limited thereto, a DLL circuit may be used as the internal clock generator 107. The internal clock generator 107 may provide the phase controlled internal clock signal LCLK to the IO circuit 170 and a timing generator 109. The IO circuit 170 may use the phase controller internal clock signal LCLK as a timing signal for determining an output timing of read data. The timing generator 109 may receive the internal clock signal ICLK and generate various internal clock signals.

The power supply terminals may receive power supply voltages VDD and VSS. These power supply voltages VDD and VSS may be supplied to a voltage generator circuit 190. The voltage generator circuit 190 may generate various internal voltages, VPP, VOD, VARY, VPERI, and the like based on the power supply voltages VDD and VSS. The internal voltage VPP is mainly used in the row decoder 130, the internal voltages VOD and VARY are mainly used in the sense amplifiers 150 included in the memory cell array 145, and the internal voltage VPERI is used in many other circuit blocks. The power supply terminals may also receive power supply voltages VDDQ and VSSQ. The IO circuit 170 may receive the power supply voltages VDDQ and VSSQ. For example, the power supply voltages VDDQ and VSSQ may be the same voltages as the power supply voltages VDD and VSS, respectively. However, the dedicated power supply voltages VDDQ and VSSQ may be used for the IO circuit 170 and the ZQ calibration circuit 175.

The calibration terminal ZQ of the semiconductor memory device 100 may be coupled to the ZQ calibration circuit 175. The ZQ calibration circuit 175 may perform a calibration operation with reference to an impedance of the ZQ resistor (RZQ) 155. In some examples, the ZQ resistor (RZQ) 155 may be mounted on a substrate that is coupled to the calibration terminal ZQ. For example, the ZQ resistor (RZQ) 155 may be coupled to a power supply voltage (VDDQ). An impedance code ZQCODE obtained by the calibration operation may be provided to the IO circuit 170, and thus an impedance of an output buffer (not shown) included in the IO circuit 170 is specified.

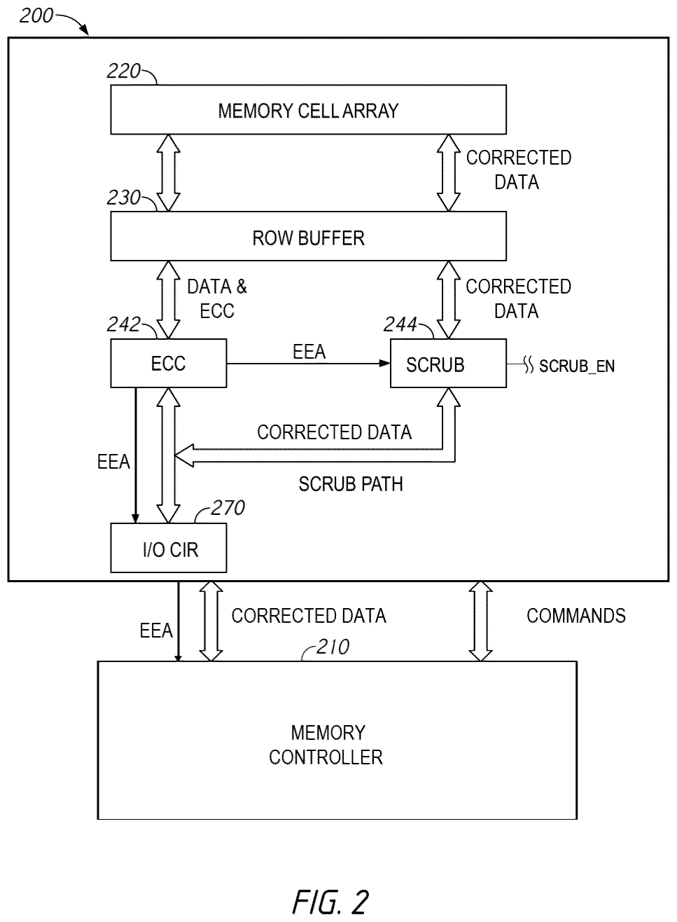

FIG. 2 is a schematic block diagram of a memory system having a portion of a semiconductor device 200 coupled to a memory controller 210, in accordance with an embodiment of the present disclosure. For example, the semiconductor device 200 may include a memory cell array 220, a row buffer 230, an ECC circuit 242, a scrub circuit 244, and an I/O circuit 270. The semiconductor device 100 of FIG. 1 may implement the portion of the semiconductor device 200, in some examples. The memory controller 210 may be configured to receive corrected data and EEA signals from the semiconductor device 200 and may be configured to provide write data and commands to the semiconductor device 200.

The memory cell array 220 may be configured to store (e.g., write) data as part of a write operation and may be able to provide (e.g., read) stored data a part of a read operation. The memory cell array 220 may include volatile memory, such as those implemented in DDR4/5/6, LPDDR5, GDDR4/5/6, etc., DRAM devices. The row buffer 230 may temporarily store data (and a corresponding ECC) that is to be written to or data (and a corresponding ECC) that is to be read from the memory cell array 220.

The ECC circuit 242 may receive the data and the ECC from the memory cell array 220 during a read operation and may perform an ECC operation to detect and/or correct errors in the data prior to providing the data to the I/O circuit 270. During a write operation, the ECC circuit 242 may receive data from the I/O circuit 270 and may perform an ECC operation to generate an ECC and may provide both the data and the ECC to the row buffer 230. The I/O circuit 270 may be configured to interface with the memory controller 210 to provide and receive data over a data bus.

During both read and write operations, a row of memory cells of the memory cell array 220 corresponding to a particular address may be opened (e.g., available to store or retrieve data) via column and row decoders (not shown). During the write operation, the write data may be received at ECC circuit 242 via the I/O circuit 270, and the ECC circuit 242 may generate a corresponding ECC based on the data and may provide the data and the generated ECC to the row buffer 230. The data and the corresponding ECC may be read from the row buffer 230 and written to the memory cell array 220. During a read operation, read/write amplifiers may cause the data along with the corresponding ECC to be read from the memory cell array 220 into the row buffer 230. The read data and the ECC may be transferred to the ECC circuit 242 from the row buffer 230. The ECC circuit 242 may use the ECC to determine whether the data read from the memory matches expected data. In some examples, the ECC circuit 242 may be capable of correcting the errors in the data using the ECC prior to provision to the I/O circuit 270. However, the data stored at the memory cell array 220 may remain corrupted until a scrub operation is performed. The semiconductor device 200 may notify the memory controller 210 of the corrupted data. For example, the ECC circuit 242, via the I/O circuit 270, may send an ECC error alert signal EEA, along with the corrected data, to the memory controller 210 via a direct media interface (DMI) terminal to notify the memory controller 210. Depending on a mode of operation, the memory controller 210 or the semiconductor device 200 may initiate a scrub operation. For example, in one mode, a scrub operation may be initiated by a memory controller 210 in response to the EEA signal indicating that the stored data is corrupted. When initiated by the memory controller 210, the scrub operation is effectively a full write back operation.

However, when the semiconductor device 200 is configured for self-controlled scrub operations (e.g., self-controlled scrub mode enabled), a scrub circuit 244 may be configured to cause corrected data to be written back to the memory cell array 220 as part of the read operation. In some examples, the scrub operation may be limited to certain error correction modes. For example, if the ECC circuit 242 is capable of correcting up to two detected bit errors, the scrub circuit 244 may only perform a scrub operation when two bit errors are detected (e.g., and not perform a scrub operation when only one bit error is detected). In other examples, the scrub circuit 244 may be configured to perform a scrub operation when any number of correctable bit errors are detected.

The self-controlled scrub mode may be enabled by a mode register setting, which may be set based on a command from the memory controller 210. The scrub enabled signal SCRUB_EN may indicative of the mode register setting. When enabled, when the ECC circuit 242 performs a prescribed data correction, the scrub circuit 244 may be configured to receive the corrected data and error flags and may cause the corrected data to be written back to the memory cell array 220 via the row buffer 230. If the 267 initiates a scrub operation, the semiconductor device 200 may provide an indication with the corrected data to the memory controller 210, and in response, the memory controller 210 may delay initiation of a next access operation (or may delay a time to sense data from the data terminals DQ if the subsequent access operation has been initiated) to allow the scrub operation to complete. That is, correcting the inconsistent data during the read operation may introduce a slight delay or increased latency as compared with a typical read operation, but may save time and power overall as compared with a scrub operation controlled by the memory controller 210 (e.g., an operation that includes performing a full write back operation).

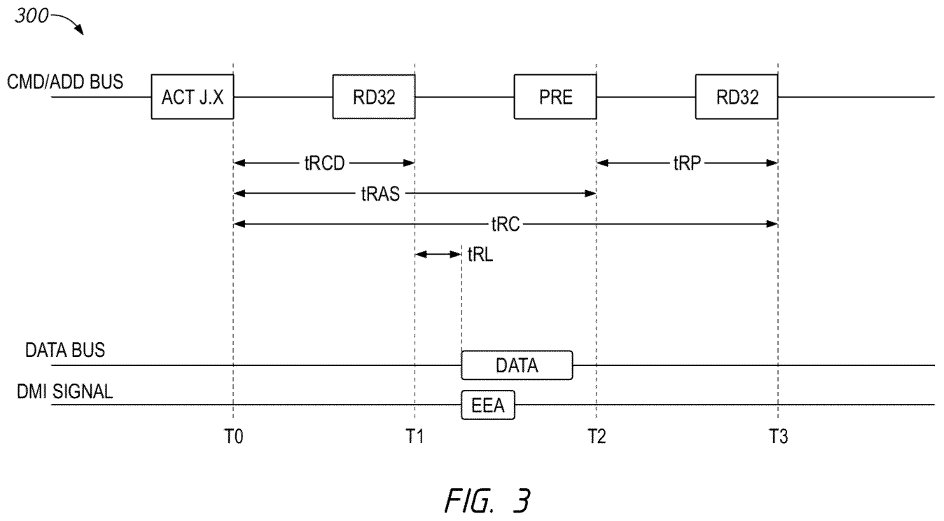

FIG. 3 is a timing diagram 300 of a read operation with no self-scrub operation at a semiconductor device, in accordance with an embodiment of the present disclosure. The timing diagram 300 may correspond to operations performed by the semiconductor device 100 of FIG. 1 or the semiconductor device 200 of FIG. 2.

At time TO, a activate command associated with bank J, row X may be received via a command and address bus, such as the command and address bus 110 of FIG. 1. Between times T0 and T1, bank J, the process of opening row X of bank J of the memory cell array may be executed. The delay between times T0 and T1 may be a row access strobe (RAS) to column access strobe) CAS delay or tRCD. At time T1, row X of bank J of the memory cell array may be in a state to read the data, which may start after a read latency tRL. The data may be fully read between T1 and T2. Also between times T1 and T2, an ECC circuit (e.g., the ECC circuit 166 of FIG. 1 or the ECC circuit 242 of FIG. 2) of the semiconductor device may detect and/or correct errors in the read data, and may set an ECC error alert (EEA) signal indicating whether any (and/or how many) errors are detected. For example, the EEA signal may indicate no errors, one error, two errors, or more than two errors. In some examples, the ECC circuit may be capable of correcting up to two errors.

At time T2, the precharge cycle may start, which may close row X of bank J so that a next row can be opened. The time between T0 and T2 is the minimum number of clock cycles between the activate command and a start of the precharge cycle or tRAS. Between times T2 and T3, the row precharge time tRP, row X may be closed. At time T3, a second activate command may be received for row Y of bank J. In response, another read operation may commence for row Y of bank J. The total time between T0 and T3 is the minimum activate command to activate command time or tRC.

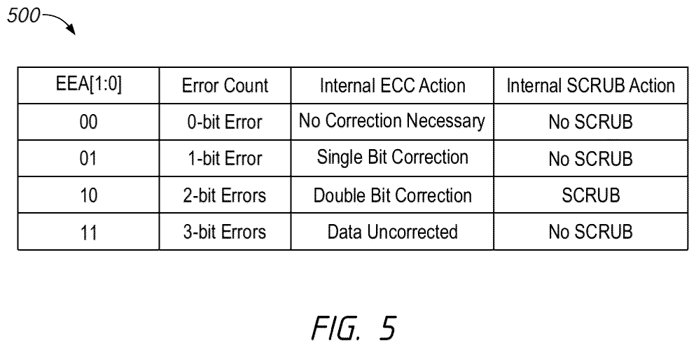

The timing diagram 300 depicts a read operation where the self-scrub mode is not enabled (e.g., rather, scrub operations are performed by the memory controller, such as the memory controller 210 of FIG. 2) or there are not sufficient errors to cause a scrub operation to be performed. That is, when the self-scrub operation is enabled, a self-scrub may only be performed when a certain number of errors are detected. For example, FIG. 5 includes a table 500 that illustrates when a self-scrub operation is performed, in accordance with embodiments described herein. The table 500 indicates a value of the EEA corresponding to a number of errors detected, actions taken by the ECC circuit, and whether a scrub operation is performed. As indicated in the table 500, a scrub operation is only performed in the scenario where two errors are detected and corrected. Otherwise, no scrub operation is performed. The table in FIG. 5 is exemplary, and it is appreciated that other embodiments may implement scrub operations in more scenarios, such as when one bit error is detected.

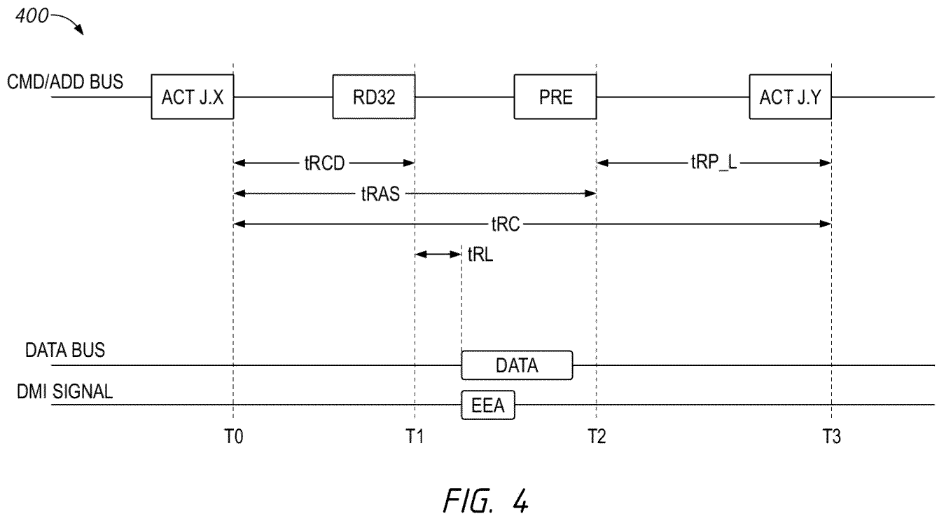

FIG. 4 is a timing diagram 400 of a read operation with a self-scrub operation at a semiconductor device, in accordance with an embodiment of the present disclosure. The timing diagram 400 may correspond to operations performed by the semiconductor device 100 of FIG. 1 or the semiconductor device 200 of FIG. 2. The timing diagram 400 may be similar to the timing diagram 300 of FIG. 3, except that a scrub operation is performed in the timing diagram 400. Thus, the timing diagrams 300 and 400 are identical up until time T2. In the interest of brevity and clarity, a description of those time periods will not be repeated for FIG. 4.

In the timing diagram 400, at time T2, the precharge cycle may start, but the closing of the row may be delayed while corrected data is written back to the row. This brief delay may be added to the tRP, which may become tRP_L. The memory controller, in response to the EEA indicating a scrub operation is being performed at the semiconductor device, may base the next activation command timing at time T3 on the tRP_L latency or delay. When the EEA indicates no scrub operation is being performed at the semiconductor device, the memory controller may base the next activation command timing at time T3 on the tRP_L latency or delay. Implementation of the self-scrub (e.g., semiconductor controlled) operation may decrease power consumption and latency over memory controller-controlled scrub operations.

The timing diagrams 300 and 400 are exemplary for illustrating operation of various described embodiments. Although the timing diagrams 300 and 400 depict a particular arrangement of signal transitions of the included signals, one of skill in the art will appreciate that additional or different transitions may be included in different scenarios without departing from the scope of the disclosure. Further, the depiction of a magnitude of the signals represented in the timing diagrams 300 and 400 are not intended to be to scale, and the representative timing are illustrative examples of a timing characteristics.

Although the detailed description describes certain preferred embodiments and examples, it will be understood by those skilled in the art that the scope of the disclosure extends beyond the specifically disclosed embodiments to other alternative embodiments and/or uses of the embodiments and obvious modifications and equivalents thereof. In addition, other modifications which are within the scope of the disclosure will be readily apparent to those of skill in the art. It is also contemplated that various combination or sub-combination of the specific features and aspects of the embodiments may be made and still fall within the scope of the disclosure. It should be understood that various features and aspects of the disclosed embodiments can be combined with or substituted for one another in order to form varying mode of the disclosed embodiments. Thus, it is intended that the scope of at least some of the present disclosure should not be limited by the particular disclosed embodiments described above.

What is claimed is:

1. An apparatus comprising:
an error correction code (ECC) circuit configured to, during a read operation, receive read data from a target row of a memory cell array and an ECC from the memory cell array and to detect errors in the read data using the ECC, wherein the ECC circuit is configured to provide an ECC error alert (EEA) signal having a value based on a number of errors detected in the read data, wherein the ECC circuit is further configured to provide corrected read data in response to a determination that the read data has two or fewer errors, otherwise the ECC circuit is configured to provide the read data as the corrected read data; and
a scrub circuit configured to, while a self-scrub mode is enabled and during a read operation, receive the corrected read data and the EEA and in response to the EEA having a scrub required value, cause the corrected read data to be written back to the target row of the memory cell array.

2. The apparatus of claim 1, wherein the scrub circuit is further configured to receive a scrub enable signal and to determine whether the self-scrub mode is enabled based on the scrub enable signal.

3. The apparatus of claim 2, further comprising a mode register configured to store a self-scrub enable setting indicating whether the self-scrub mode is enabled, wherein the self-scrub enable signal is set to a value based on the self-scrub enable setting in the mode register.

4. The apparatus of claim 1, wherein the scrub circuit is further configured to skip writing the corrected read data back to the target row of the memory cell array while the self-scrub mode is disabled.

5. The apparatus of claim 1, wherein the scrub circuit is further configured to skip writing the corrected read data back to the target row of the memory cell array in response to the EEA having a no scrub required value.

6. The apparatus of claim 1, wherein the scrub required value of the EEA indicates two errors were detected.

7. The apparatus of claim 1, further comprising an input/output circuit configured to provide the corrected data and the EEA to a memory controller, wherein a time until initiation of a next read operation may be based on the EEA.

8. The apparatus of claim 1, further comprising a row decoder configured to cause the target row to close after the corrected read data is written back to the target row of the memory cell array.

9. The apparatus of claim 1, wherein the corrected read data is written back to the target row of the memory cell array during a precharge phase of the read operation.

10. A system comprising:
a memory comprising an error correction code (ECC) circuit configured to, during a read operation corresponding to a first read command, detect and correct an error in read data read from a target row of a memory cell array using an ECC read from the memory cell array and to provide corrected read data and a ECC error alert (EEA) signal having a value based on a number of errors detected in the read data, the memory further comprising a scrub circuit configured to, during the read operation and in response to self-scrub mode being enabled, receive the corrected read data and the EEA and in response to the EEA having a scrub required value, cause the corrected read data to be written back to the target row of the memory cell array; and
a memory controller configured to receive the corrected read data and the EEA, wherein, in response to the EEA having the scrub required value, the memory controller is configured to delay provision of a second read command by a first latency that is different than a second latency used when the EEA has a no scrub required value.

11. The system of claim 10, wherein the memory controller is configured to send a command to the memory to enable the self-scrub mode.

12. The system of claim 11, wherein the memory further comprises a mode register configured to store a status of the self-scrub mode in response to the command from the memory controller.

13. The system of claim 10, wherein, in response to the self-scrub mode being disabled at the memory, the memory controller is configured to provide a write command and the corrected read data to the memory in response to the EEA having the scrub required value.

14. The system of claim 10, wherein the scrub circuit is further configured to skip writing the corrected read data back to the target row of the memory cell array while the self-scrub mode is disabled.

15. A method comprising:
during a read operation:
receiving, at an error correction code (ECC) circuit of a memory, read data from a target row of a memory cell array and an ECC from the memory cell array;
detecting errors in the read data using the ECC;
providing an ECC error alert (EEA) signal having a value based on a number of errors detected in the read data;
providing corrected read data based on the detected errors;
while a self-scrub mode is enabled and in response to the EEA having a scrub required value, cause the corrected read data to be written back to the target row of the memory cell array.

16. The method of claim 15, further comprising skipping writing of the corrected read data back to the target row of the memory cell array while the self-scrub mode is disabled.

17. The method of claim 15, further comprising skipping writing of the corrected read data back to the target row of the memory cell array in response to the EEA having a no scrub required value.

18. The method of claim 15, further comprising providing the corrected read data and the EEA to a memory controller.

19. The method of claim 15, further comprising writing the corrected read data is back to the target row of the memory cell array during a precharge phase of the read operation.

20. The method of claim 15, further comprising storing a self-scrub enable setting indicating whether the self-scrub mode is enabled at a mode register of the memory.
